(19) United States
(12) Patent Application Publication
(10) Pub. No.: US 2007/0124477 A1
(43) Pub. Date: May 31, 2007

(54) Load Balancing System

(76) Inventor: Cameron Kenneth Martin, Winchester (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/563,716

(22) Filed: Nov. 28, 2006

(30) Foreign Application Priority Data
Nov. 29, 2005 (GB) 0524256.5

(51) Int. Cl. G06F 15/173

(52) U.S. Cl. 709/226

(57) ABSTRACT

A load balancing system for routing a request sent by a first computer, wherein the request is operable to initiate a communication protocol with a second computer, wherein the second computer is operable to process the request, and wherein the first computer comprises an inserter being operable to insert data associated with the second computer in the request. The system comprises a receiver for receiving the initiation request, and a comparator responsive to receipt of the initiation request, for comparing the data in the request with data in a storage component in order to determine a routing decision.

### FIELD OF THE INVENTION

The present invention relates to a load balancing system.

### BACKGROUND OF THE INVENTION

Increasingly, the Internet is becoming popular as a medium for electronic transactions, for example, between a customer's client computer and a vendor's server computer.

The World Wide Web (WWW) is a wide area information retrieval facility which provides access to an enormous quantity of network-accessible information.

With reference to FIG. 1, in the World Wide Web (WWW) environment (100), a client computer (105) communicates over the Internet (115) with Web servers (i.e. Server 1 and Server 2) using the Hypertext Transfer Protocol (HTTP). It should be understood that Server 1 and Server 2 can also be application servers, The Web servers provide users with access to files such as text, graphics, images, sound, video, etc., using a standard page description language known as Hypertext Markup Language (HTML). HTML provides basic document formatting and allows a developer to specify connections known as hyperlinks to other servers and files. In the Internet paradigm, a network path to a Web server is identified by a Uniform Resource Locator (URL) having a special syntax for defining a network connection.

A Web browser (110), for example, Netscape Navigator (Netscape Navigator is a registered trademark of Netscape Communications Corporation) or Microsoft Internet Explorer (Microsoft, is a trademarks of Microsoft Corporation in the United States, other countries, or both), which is an application running on the client computer (105), enables a user to access information by specification of a link (i.e. an HTTP request) via the URL and to navigate between different HTML (Web) pages.

Along with the increase in the level of activities on the Internet, the need to exchange sensitive data over secured channels becomes important as well. Secure Sockets Layer (SSL) protocol is a defacto standard from Netscape Communications Corporation for establishing a secure channel for communication over the Internet, whereby data can be sent securely utilizing that channel, between a server computer and a client computer. A subsequent enhancement to Secure Sockets Layer known as Transport Layer Security (TLS) is also commonly used. TLS operates in a similar manner to SSL and the two protocols will be referred to herein as “SSL”.

The SSL protocol comprises two sub-protocols, namely, the SSL Handshake protocol and the SSL Record protocol. The SSL Handshake protocol utilises the SSL Record protocol to allow a Web server computer and client computer to authenticate each other and negotiate an encryption algorithm and cryptographic keys before any data is communicated. Typically, the client computer sends a non-encrypted initiation message (known as a ClientHello message) to the Web server. In response, the Web server sends a ServerHello message comprising keys, certificates etc. The ServerHello message comprises a non-encrypted identifier (i.e. session_id).

The client computer and Web server can exchange several further messages in the handshaking process. Once handshaking has been completed, an SSL connection is established that is encrypted using the negotiated keys etc.

The client computer and Web server can now exchange application level data using the SSL Record Protocol over the SSL connection. The SSL Record protocol is layered on top of some reliable transport protocol, such as the Transport Control Protocol (TCP) and defines the format for data transmission, In operation, an HTTP request is sent across the encrypted SSL connection to the Web server. An HTTP response is sent across the encrypted SSL connection from the Web server to the client computer. The use of HTTP over an SSL connection is known as HTTPS.

Due to the amount of traffic on the Internet, a Web site is typically supported by a plurality of Web servers, known as a Web farm. A major performance challenge is to balance the load on the Web servers effectively, so as to minimize the average response time achieved on the system, Over-utilization of Web servers can cause excessive delays of requests. On the other hand., under-utilization of Web servers is wasteful.

A load balancer (120) is responsible for routing a request from a client computer (105) to a Web server (i.e. Server 1 or Server 2) over a network (125). Typically, the request can be routed to a Web server randomly. Alternatively the request can be routed to a Web server based on a function associated with a state of a Web Server (e.g. capacity of the Web server).

It is often also desirable to route an HTTP request from a given client computer to a given Web server (or group of Web servers) within a Web farm. For example, if a particular type of HTTP request requires a particular type of Web server function for processing of the HTTP request, it is desirable for the particular HTTP request to be routed to a Web server comprising the particular function. This prevents the need for duplication of functionality across Web servers, the need for Web servers to collaborate, etc.

In order to route an HTTP request in this way, a toad balancer needs to analyse data associated with an HTTP request. For a non-secure HTTP request the HTTP request can be inspected at two different levels.

In a first instance, one or more TCP packets comprising an HTTP request can be inspected for data comprised in the TCP packets by inspecting data comprised in associated TCP headers, e.g. source and destination IP address and/or port. However this data can be insufficient for HTTP request routing purposes. For example, making a routing decision based on data associated with an HTTP header itself is not possible, as this data is not comprised in a TCP header.

In a second instance, an HTTP request itself can be inspected for data comprised in the HTTP request e.g. a hostname associated with a target Web server; a URI associated with a resource being requested, data associated with a specific HTTP header, etc.

For an HTTP request sent over an SSL connection (i.e. an HTTPS request), a load balancer acting solely at the TCP level is unable to read data comprised in the HTTPS request and thus is unable to ensure that a given HTTPS request is directed to a target Web server based on data associated with the HTTPS request.

Thus, while a load balancer is able to make a routing decision based on data associated with a TCP header (e.g. source or destination IP address and/or port), the load balancer is unable to route a request based on data associated with the HTTPS request if the load balancer is only acting at a TCP level.

In order for the load balancer to be able to inspect an HTTPS request, an SSL connection must be terminated at the load balancer. This allows the load balancer to inspect the HTTP request and the load balancer proxies the HTTP request to a target Web Server, ie. an HTTPS proxy is created at the load balancer.

It should be understood in order to proxy a request, the HTTPS proxy creates a new HTTPS request. That is, a new SSL connection is created between the HTTPS proxy and the Web server in order to send an HTTPS request to the Web server. The SSL connection is also used to communicate responses from the Web Server to the HTTPS proxy. The response can then be sent from the HTTPS proxy to the client computer. Thus, the HTTPS proxy performs encryption associated with SSL on the HTTPS request.

This significantly increases the performance burden associated with processing HTTPS requests, because the HTTPS proxy is typically required to have a similar processing capability to that associated with a Web Server, as both the Web Server and the HTTPS proxy will need to perform SSL encryption/decryption for a given request.

In comparison, the typical function of a load balancer is to route, rewrite or perform network address translation for TCP packets comprising an HTTP request. A load balancer which is performing simple TCP routing, rewriting and/or network address translation does not require the significant processing resources associated with re-establishing an SSL connection and with handling responses from a Web server.

Furthermore, termination of an SSL connection at the load balancer is a security risk. This is because, if the load balancer is compromised or if after decrypting the HTTPS request at the load balancer, the request is sent using HTTP and the network (125) between the load balancer and a target Web server is compromised, then all data sent between a client computer and a target Web server is compromised.

Furthermore introduction of an HTTPS proxy at the load balancer can introduce complexity for an application. This is because the HTTPS proxy may not be transparent to the application. For example, a technique of absolute HTTP redirects can no longer be used. This is because absolute URLs for content accessed on the target Web server directly and for content accessed on the target Web server via an HTTPS proxy are now different.

A welt established technique for providing routing data when an SSL connection request is received from a client computer is to maintain a table associating an SSL Session ID with a target Web Server. Upon a first SSL connection being established, the load balancer routes an HTTP request to a target Web server and stores data in the table that associates an SSL Session ID and the target Web server.

When the client computer creates a new TCP connection and requests the resumption of an existing SSL session on a subsequent SSL connection, the client computer can send an SSL Session ID to the load balancer. The load balancer reads the SSL Session ID (because the SSL Session ID is not encrypted). The load balancer uses the SSL Session ID to consult the table as input to a routing decision (e.g. for an HTTPS request). That is, the load balancer compares the SSL Session ID with the table, determines the target Web Server associated with the SSL Session ID and sends the HTTPS request to the target Web Server.

However, the table is limited to providing routing data based only on a link associated with the first SSL connection for a given SSL Session ID,

### DISCLOSURE OF THE INVENTION

According to a first aspect, there is provided a load balancing system for routing a request sent by a first computer, wherein the request is operable to initiate a communication protocol with a second computer, wherein the second computer is operable to process the request, and wherein the first computer comprises an inserter being operable to insert data associated with the second computer in the request, the system comprising: a receiver for receiving the initiation request; and a comparator, responsive to receipt of the initiation request, for comparing the data in the request with data in a storage component in order to determine a routing decision.

Preferably, the first computer is operable to send the data to the receiver, More preferably, in response to the receiver receiving the data, the data is stored in the storage component.

In a preferred embodiment, in response to establishing the communication protocol, the second computer is operable to send an identifier to at least one of: the receiver and the first computer Preferably, in response to receiving the identifier, further data associated with the identifier and the associated second computer is stored in the storage component. More preferably, the first computer is operable to resume the established communication protocol by sending a resumption request comprising the identifier. Still more preferably, the comparator, in response to receipt of the resumption request, compares the identifier in the resumption request with the further data in the storage component.

According to a second aspect, there is provided a method for use with a load balancing system for routing a request sent by a first computer, wherein the request is operable to initiate a communication protocol with a second computer, wherein the second computer is operable to process the request; and wherein the first computer comprises an inserter being operable to insert data associated with the second computer in the request, the method comprising the steps of: receiving, by a receiver, the initiation request; and in response to receipt of the initiation request, comparing the data in the request with data in a storage component in order to determine a routing decision.

According to a third aspect, there is provided a computer program comprising program code means adapted to perform all the steps of the method described above when said program is run on a computer.

It should be understood that any data can be inserted into the request. For example, some existing cipher suite data can be removed from the request and the remaining cipher suite data can be inserted into the request. Thus, a routing decision can be made upon a determination of an absence of cipher suite data.

Advantageously, no changes are required to the Web server.

### BRIEF DESCRIPTION OF THE DRAWINGS

The present invention will now be described, by way of example only, with reference to preferred embodiments thereof, as illustrated in the following drawings:

FIG. 1 is a block diagram of a system in which the preferred embodiment can be implemented;

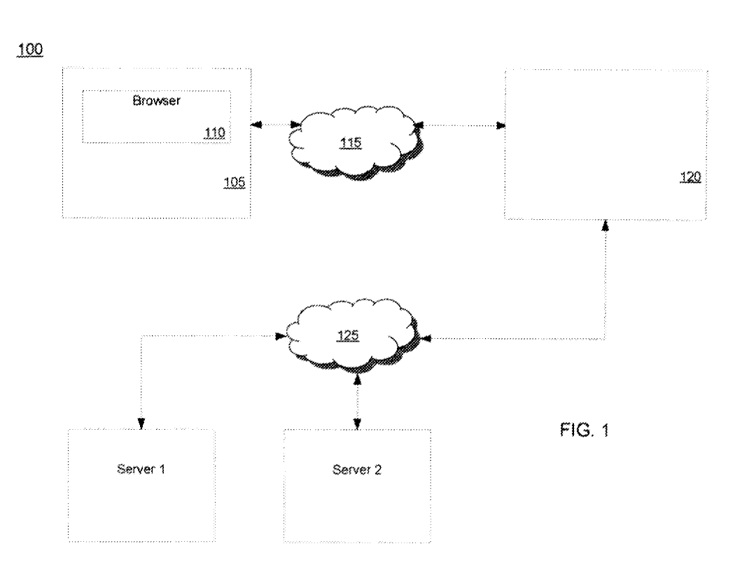

FIG. 2 is a more detailed diagram of the system in FIG. 1, in which the preferred embodiment can be implemented;

FIG. 3 is a flow chart showing the operational steps involved in a process associated with a load balancer; and

FIG. 4 is a schematic diagram of the components involved in a load balancing environment and the flows between those components.

### DETAILED DESCRIPTION OF THE PREFERRED EMBODIMENTS

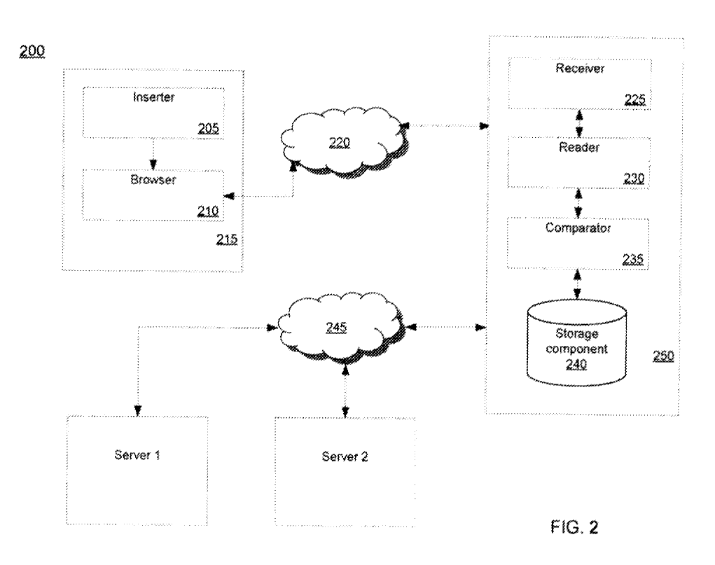

With reference to FIG. 2, there is shown a block diagram of a system (200) in which the preferred embodiment can be implemented. A client computer (215) comprises an inserter (205) and a Web browser (210). The client computer (215) communicates with a load balancer (250) over a network (220). The load balancer (250) comprises a receiver (225), a reader (230) and a comparator (235) that accesses a storage component (240). The load balancer (250) communicates with Web servers (Server 1 and Server 2) over a network (245). The preferred embodiment will now be described with reference to HTTP and SSL. However, it should be understood that the preferred embodiment can be used with any number of protocols.

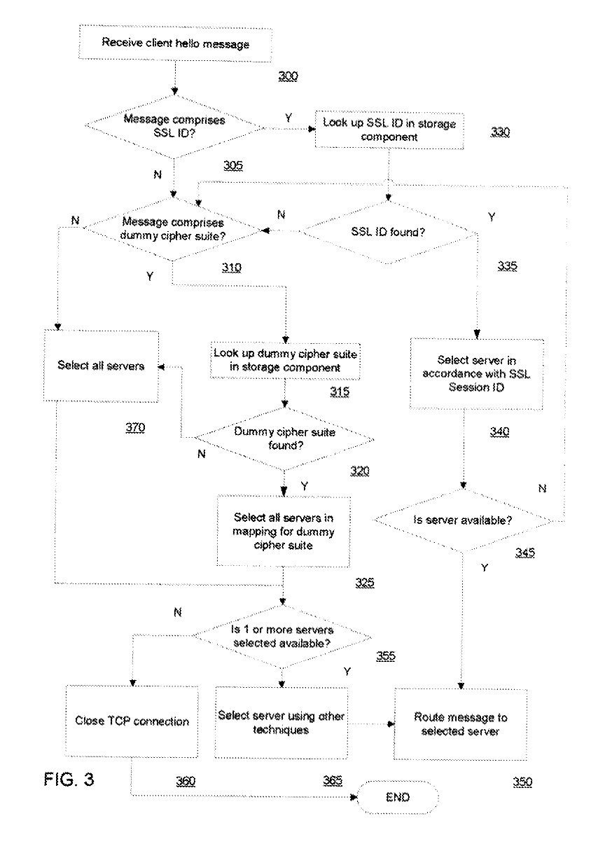

With reference to FIG. 3, there is shown a flow chart showing the operational steps involved in a process associated with a load balancer (250), The client computer (215) establishes a TCP connection with the load balancer (250). The client computer (215) generates a ClientHello message. An example of the structure of a ClientHello message is shown below:

struct {

ProtocolVersion client_version;
Random random;
SessionID session_id;
CipherSuite cipher_suites<2..2¹⁶−1>;
CompressionMethod compression_methods<1..2⁸−1>

} ClientHello;

With reference to the above structure, the field “client_version” represents the version of the SSL protocol being used by the client computer. The field “random” represents a client-generated random structure —e.g., for a challenge. The field “session_id” represents the SSL Session ID associated with an SSL connection. The “session_id” is empty if no SSL ID is available or if a new SSL connection is being requested by a client computer.

The field “cipher_suites” represents cryptographic options supported by the client computer. Preferably, the client computer (215) comprises an inserter (205) for inserting “dummy” cipher suite data in the “cipher suites” field. The dummy cipher suite data is associated with a target Web server. Preferably, this association is communicated to the load balancer (250).

The field “compression_methods” represents compression methods supported by the client computer.

Preferably, the load balancer (250) maintains a table in the storage component (240) that associates dummy cipher suite data with a target Web server in response to receiving an association from the client computer (215).

The dummy cipher suite data is used as input to the making of an initial routing decision. The dummy cipher suite data can be mapped to a plurality of target Web servers. It should be understood that data associated with a target Web server can be added to any other field in the initiation message (e.g. the compression_methods field). Furthermore., for other types of initiation message, the data associated with a target Web server can be added in a unique fiend. The table is termed “cipher suite table” herein. A representation of the table is shown below:

TABLE 1

| | |
|---|---|
| Dummy cipher suite | Target Web Servers |

Preferably, the load balancer (250) maintains a table in the storage component (240) that associates an SSL Session ID with a target Web server by performing a process as described above. The SSL Session ID is mapped to only one target Web server, because only that target Web server knows how to resume the SSL connection associated with that SSL Session ID. Thus, the SSL Session ID is used as input to the making of a routing decision upon SSL connection resumption. The table is termed “SSL ID table” herein.

A representation of the table is shown below:

TABLE 2

| | |
|---|---|
| SSL Session ID | Target Web Server |

The receiver (225) receives (300) the ClientHello message. The load balancer (250) comprises a reader (230) that reads the ClientHello message in order to determine (step 305) whether the ClientHello message comprises an SSL Session ID. If the ClientHello message comprises an SSL Session ID, an SSL connection has already been established and the ClientHello message is requesting resumption of the connection.

In this case, the load balancer (250) comprises a comparator (235) that compares (step 330) the SSL Session ID with Table 2. The comparator (235) determines (step 335) whether the SSL Session ID has been found.

In response to an entry comprising the SSL Session ID not being found, the load balancer (250) determine (step 310) whether the ClientHello message comprises dummy cipher suite data described later.

In response to an entry comprising the SSL Session ID being found, the load balancer (250) selects (step 340) a server in accordance with the SSL Session ID. That is, the reader (230) reads data associated with the associated target Web server.

If the target Web server is not available (step 345), the load balancer (250) determines (step 310) whether the ClientHello message comprises dummy cipher suite data described later.

If the target Web server is available, the load balancer routes (step 350) the ClientHello message to the target Web server. The target Web server determines whether it recognizes the SSL Session ID and whether it wishes to re-establish a connection. If so, the target Web server sends a ServerHello message comprising a non-encrypted SSL Session ID to the load balancer (250).

An example of the structure of a ServerHello message is shown below:

struct {

ProtocolVersion server_version;
Random random;
SessionID session_id;
CipherSuite cipher_suites<2..2¹⁶˜1>;
CompressionMethod compression_methods<1..2⁸−1>

} ServerHello;

With reference to the above structure: the field “server_version” represents the version of the SSL protocol being used by the Web server. The field “random” represents a server-generated random structure. The field “session_id” represents the SSL Session ID associated with an SSL connection. The field “cipher_suites” represents a cryptographic option supported by the client computer and selected by the Web server. The field “compression_methods” represents a compression method supported by the client computer and selected by the Web server.

The load balancer (250) sends the ServerHello message comprising a non-encrypted SSL Session ID to the client computer (215). The remaining SSL Handshake protocol messages required to complete the handshake can now take place and application level data (e.g. HTTPS requests and responses) can now be exchanged.

It should be understood that in order for a load balancer to route a message in accordance with the SSL ID, a connection has to have been already established. Furthermore, the routing in accordance with an SSL ID is made based on a previous routing made when the first SSL connection was established.

In response to the ClientHello message not comprising an SSL Session ID or in response to the SSL Session ID not being found in Table 2 or if a selected server is not available at step 345, the reader (230) reads the ClientHello message in order to determine (step 310) whether the ClientHello message comprises dummy cipher suite data.

In response to the ClientHello message comprising dummy cipher suite data, the comparator (235) compares (step 315) the dummy cipher suite data with Table 1. The comparator (235) determines (step 320) whether the dummy cipher suite data has been found.

In response to an entry comprising the dummy cipher suite data not being found the process passes to step 370, described later.

In response to an entry comprising the dummy cipher suite data being found, the load balancer (250) selects (step 325) all target Web servers associated with the dummy cipher suite data. That is, the reader (230) reads data associated with the associated target Web servers.

In response to all of the target Web servers not being available (step 355), the TCP connection is closed (360).

In response to one or more of the selected target Web servers being available, preferably, the load balancer uses a further technique to select (step 365) a target server. For example, the message is routed to a random server; the message is routed based on server load; the message is routed based on TCP data etc. The load balancer routes (step 350) the ClientHello message to the selected target Web server. The handshaking process can continue and once finished, an SSL connection is established and the application level data can be exchanged.

Thus it should be understood that dummy cipher suite data is used as input to the making of a routing decision when an SSL connection is to be initiated. The SSL ID is used as input to the making of a routing decision when an SSL connection is to be resumed, with the dummy cipher suite data used as an input if the SSL connection cannot be resumed.

In response to the ClientHello message not comprising dummy cipher suite data, the load balancer (250) selects all servers (step 370) and the process passes to step 355.

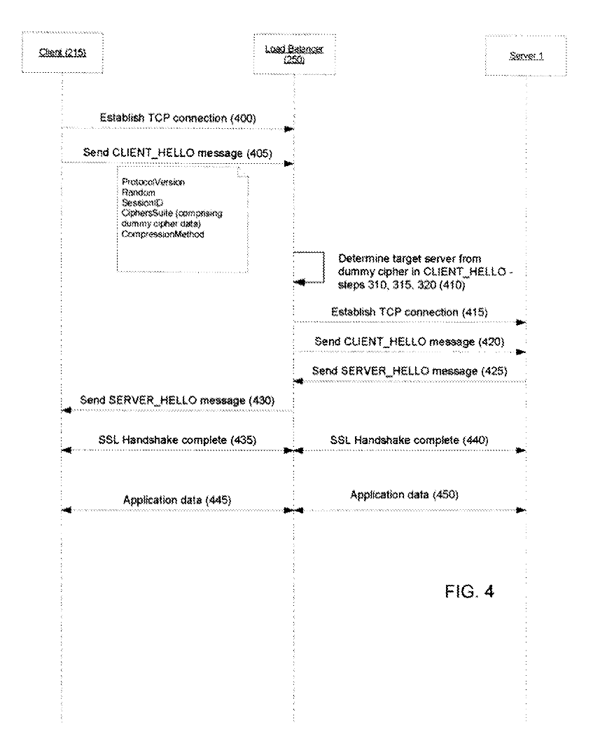

The first example will now be described with reference to FIG. 4, where there is shown a schematic diagram of the components involved in a load balancing environment and the flows between those components. In the first example, an initial ClientHello message is sent by the client computer (215) in order to establish a new SSL connection (i.e. no previous SSL connection has been established).

The client computer (215) generates an initial non-encrypted ClientHello message and the inserter (205) inserts dummy cipher suite data in the ClientHello message. In the first example the message is from a company (i.e. XYZ bank) and the message is targeted to a server that handles requests from banks having a company name that starts with a letter “M-Z”. The dummy cipher suite data is “{0×99,0×99}” and the target Web server is “Server 1”. Preferably, the association is communicated to the load balancer (250). Alternatively, the client computer (215) and the load balancer (250) can negotiate an association.

An example of the ClientHello message is shown below. It should be understood that the session_id is empty because an SSL connection has not been established before. It should be understood that in the cipher_suites field, actual cipher suite data is present (i.e. {0×00,0×0A }{0×00,0×09}) and dummy cipher suite data is present (i.e. {0×99,0×99}).

struct {

ProtocolVersion 3.0;
Random 1234567890123456789012345678;
SessionID <empty>;
CipherSuite { 0x00,0x0A } { 0x00,0x09 } { 0x99,0x99 };
CompressionMethod <empty>;

} ClientHello;

At step 400, the client computer (215) establishes a TCP connection with the load balancer (250). Next, the client computer (215) sends (step 405) the ClientHello message to the load balancer (250). In response to receiving the ClientHello message, the reader (230) reads the ClientHello message in order to determine whether the ClientHello message comprises an SSL ID. In the first example, the ClientHello message does not comprise an SSL ID and thus, the reader (230) reads the ClientHello message in order to determine whether the ClientHello message comprises dummy cipher suite data.

In response to the ClientHello message comprising dummy cipher suite data, the load balancer determines (step 410) a target Web server. That is, the comparator (235) compares (step 315) the dummy cipher suite data with the cipher suite table. A representation of the table is shown below:

TABLE 3

| Dummy cipher suite | Target Web Server |
|---|---|
| {0x99, 0x99} | Server 1 |

The comparator (235) determines (step 320) whether the dummy cipher suite data has been found. The comparator (235) finds an entry comprising the dummy cipher suite data in Table 3. In response to the dummy cipher suite data being found, the reader (230) reads data associated with the target Web server (i.e. “Server l ”).

Server 1 is available and the load balancer (250) establishes (step 415) a TCP connection with Server 1. The load balancer (250) routes (step 350 and 420) the ClientHello message to Server 1. In response to receiving the ClientHello message, Server 1 generates a ServerHello message. An example of the ServerHello message is shown below,

It should be understood that an SSL session ID is now comprised in the session_id field. It should be understood that Server 1 selects a cipher suite from the options presented by the client computer (215). Preferably, the dummy cipher suite is not selected by Server 1, as preferably, Server 1 does not have the dummy cipher suite configured as a selectable option. Thus, a cipher suite from the remaining set of cipher suites is selected by Server 1. Server 1 can select the cryptographically strongest cipher suite presented by the client or can select any cipher suite using any other policy. The selected cipher suite is {0×00,0×0A }.

struct {

ProtocolVersion 3.0;
Random 1234567890123456789012345678;
SessionID 12345678901234567890123456789012;
CipherSuite { 0x00,0x0A };
CompressionMethod <empty>;

} ServerHello;

Server 1 sends (step 425) the ServerHello message to the load balancer (250).

In response to receiving the ServerHello message the load balancer (250) sends (step 430) the ServerHello message to the client computer (215). Further messages can be exchanged until the handshaking process completes (steps 435 and 440). Typical SSL functionality is now undertaken and application level data can be exchanged (steps 445 and 450).

As described above, the load balancer (250) stores data in the SSL table. A representation of the table is shown below:

TABLE 4

| SSL Session ID | Target Web Server |
|---|---|
| 12345678901234567890123456789012 | Server 1 |

In a connection resumption message, the client computer (215) sends the SSL Session ID. An example of a connection resumption message is shown below:

struct {

ProtocolVersion 3.0;
Random 0123456789012345678901;
SesssonID 12345678901234567890123456789012;
CipherSuite { 0x00,0x0A } { 0x00,0x09 } { 0x99,0x99 };
CompressionMethod <empty>;

} ClientHello;

Thus, on connection resumption, the load balancer compares the SSL Session ID in the connection resumption message against Table 4, in order to route the connection resumption message to the target Web server (i.e. Server 1) as described in FIG. 3.

It should be understood that by adding data associated with a routing decision to a non-encrypted initiation message, the data is provided to the load balancer at the earliest stage in communications. In contrast, using an SSL ID as input to the making of a routing decision requires an SSL connection to be established first.

1. A load balancing system for routing a request sent by a first computer, wherein the request is operable to initiate a communication protocol with a second computer, wherein the second computer is operable to process the request; and wherein the first computer comprises an inserter being operable to insert data associated with the second computer in the request, the system comprising:
a receiver for receiving the initiation request; and
a comparator, responsive to receipt of the initiation request, for comparing the data in the request with data in a storage component in order to determine a routing decision.

2. A system as claimed in claim 1, wherein the first computer is operable to send the data to the receiver.

3. A system as claimed in claim 2, wherein in response to the receiver receiving the data, the data is stored in the storage component.

4. A system as claimed in claim 3, wherein in response to establishing the communication protocol, the second computer is operable to send an identifier to at least one of; the receiver and the first computer

5. A system as claimed in claim 4, wherein in response to receiving the identifier, further data associated with the identifier and the associated second computer is stored in the storage component.

6. A system as claimed in claim 5, wherein the first computer is operable to resume the established communication protocol by sending a resumption request comprising the identifier.

7. A system as claimed in claim 6, wherein the comparator, in response to receipt of the resumption request, compares the identifier in the resumption request with the further data in the storage component.

8. A method for use with a load balancing system for routing a request sent by a first computer, wherein the request is operable to initiate a communication protocol with a second computer, wherein the second computer is operable to process the request; and wherein the first computer comprises an inserter being operable to insert data associated with the second computer in the request, the method comprising the steps of:
by a receiver, the initiation request; and
in response to receipt of the initiation request, comparing the data in the request with data in a storage component in order to determine a routing decision.

9. A method as claimed in claim 8, further comprising the step of; sending, by the first computer, the data to the receiver.

10. A method as claimed in claim 9, further comprising the step of; in response to the step of receiving the data, storing the data in the storage component.

11. A method as claimed in claim 10. further comprising the step of; in response to establishing the communication protocol, sending, by the second computer, an identifier to at least one of; the receiver and the first computer.

12. A method as claimed in claim 11, further comprising the step of; in response to receiving the identifier, storing further data associated with the identifier and the associated second computer in the storage component.

13. A method as claimed in claim 12, further comprising the step of; resuming, by the first computer, the established communication protocol by sending a resumption request comprising the identifier.

14. A method as claimed in claim 13, further comprising the step of; in response to receipt of the resumption request, comparing the identifier in the resumption request with the further data in the storage component.

15. A computer program comprising program code means adapted to perform all the steps of claims 14 when said program is run on a computer.
